(19) United States
(12) Patent Application Publication
(10) Pub. No.: US 2023/0057223 A1
(43) Pub. Date: Feb. 23, 2023

(54) SEGMENT COIL FORMING APPARATUS AND SEGMENT COIL FORMING METHOD

(71) Applicant: TOYOTA JIDOSHA KABUSHIKI KAISHA, Toyota-shi (JP)

(72) Inventors: Ken NODA, Nagoya-shi (JP); Takashi YAMADA, Okazaki-shi (JP); Kazushi ONDA, Toyota-shi (JP); Shoma ISHIUCHI, Nisshin-shi (JP)

(73) Assignee: TOYOTA JIDOSHA KABUSHIKI KAISHA, Toyota-shi (JP)

(21) Appl. No.: 17/809,120

(22) Filed: Jun. 27, 2022

(30) Foreign Application Priority Data
Aug. 20, 2021 (JP) 2021-134642

(51) Int. Cl. H02K 15/04

(52) U.S. Cl. CPC H02K 15/0435

(57) ABSTRACT

A segment coil forming apparatus is a segment coil forming apparatus for forming a segment coil from a wire rod, the segment coil including a projection portion, shoulder portions provided in both side portions of the projection portion, and end portions extending from the shoulder portions in a direction reverse to a direction where the projection portion projects. The segment coil forming apparatus includes: a first forming die including a first projection forming portion corresponding to the shape of the projection portion; and a second forming die including a second projection forming portion corresponding to the shape of the projection portion.

### CROSS-REFERENCE TO RELATED APPLICATION

This application claims priority to Japanese Patent Application No. 2021-134642 filed on Aug. 20, 2021, incorporated herein by reference in its entirety.

### BACKGROUND

### 1. Technical Field

The present disclosure relates to a segment coil forming apparatus and a segment coil forming method.

### 2. Description of Related Art

In the related art, there has been known a segment coil forming apparatus configured to form a segment coil used in a winding part of a rotary electric machine (see, for example, Japanese Unexamined Patent Application Publication No. 2020-61900 (JP 2020-61900 A)). The segment coil is formed by bending a wire rod such as copper and includes a projection portion, shoulder portions provided in both side portions of the projection portion, and end portions extending from the shoulder portions to a direction reverse to a direction where the projection portion projects. The segment coil forming apparatus disclosed in JP 2020-61900 A includes a metal die including a first forming die serving as a punch and a second forming die serving as a die, and a pair of rollers configured to move in the up-down direction outside the metal die. Such a segment coil forming apparatus executes first forming to form the projection portion by the metal die, and after that, the segment coil forming apparatus executes second forming to form two shoulder portions by moving the rollers downward relative to the second forming die. Hereby, a segment coil having a shape in which the projection portion is connected to the end portions via the shoulder portions is obtained.

### SUMMARY

In the meantime, it is desirable that a cycle time required to form one segment coil be as short as possible. In JP 2020-61900 A, a plurality of steps is required to form the projection portion and the two shoulder portions, and this elongates the cycle time.

In view of this, an object of a segment coil forming apparatus and a segment coil forming method described in the present specification is to reduce a cycle time required to form a segment coil.

A segment coil forming apparatus described in the present specification is a segment coil forming apparatus for forming a segment coil from a wire rod, the segment coil including a projection portion, shoulder portions provided in both side portions of the projection portion, and end portions extending from the shoulder portions toward a direction reverse to a direction where the projection portion projects. The segment coil forming apparatus includes a first forming die and a second forming die. The first forming die includes a first projection forming portion corresponding to a shape of the projection portion. The second forming die includes a second projection forming portion corresponding to the shape of the projection portion. The second forming die includes shoulder-portion forming portions provided on both sides of the second projection forming portion, the shoulder-portion forming portions being configured to form the shoulder portions. The second projection forming portion is provided such that the second forming die relatively comes close to and separates from the first forming die in a state where the second projection forming portion faces the first projection forming portion.

In the segment coil forming apparatus in the above configuration, each of the shoulder-portion forming portions may include a roller configured to make contact with the wire rod when the first forming die and the second forming die come close to each other.

Further, a segment molding method described in the present specification is a segment coil forming method for forming a segment coil from a wire rod, the segment coil including a projection portion, shoulder portions provided in both side portions of the projection portion, and end portions extending from the shoulder portions toward a direction reverse to a direction where the projection portion projects. The segment coil forming method includes forming the projecting portion and forming the shoulder portions by bringing a first forming die and a second forming die close to each other, the first forming die including a first projection forming portion corresponding to a shape of the projection portion, the second forming die including a second projection forming portion corresponding to the shape of the projection portion, the first forming die and the second forming die being brought close to each other in a state where the first projection forming portion and the second projection forming portion face each other.

With the segment coil forming apparatus and the segment coil forming method described in the present specification, it is possible to reduce a cycle time required to form a segment coil.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a schematic configuration of a segment coil forming apparatus of an embodiment;

FIG. 2A is a front view of the segment coil forming apparatus of the embodiment;

FIG. 2B is a bottom plan view of the segment coil forming apparatus of the embodiment;

FIG. 2C is a right side view of the segment coil forming apparatus of the embodiment;

FIG. 3A is a front view of a segment coil formed by the segment coil forming apparatus of the embodiment;

FIG. 3B is a bottom plan view of the segment coil formed by the segment coil forming apparatus of the embodiment;

FIG. 3C is a right side view of the segment coil formed by the segment coil forming apparatus of the embodiment;

FIG. 4A is a process drawing to form the segment coil by the segment coil forming apparatus of the embodiment;

FIG. 4B is a process drawing to form the segment coil by the segment coil forming apparatus of the embodiment; and

FIG. 4C is a process drawing to form the segment coil by the segment coil forming apparatus of the embodiment.

### DETAILED DESCRIPTION OF EMBODIMENTS

The following will describe an embodiment of the present disclosure with reference to the attached drawings. Note that, in the drawings, the dimension, the ratio, and so on of each part may not be illustrated to be completely the same as an actual dimension, an actual ratio, and so on of the each part. Further, details may be omitted in some of the drawings.

### Embodiment

Segment Coil Forming Apparatus

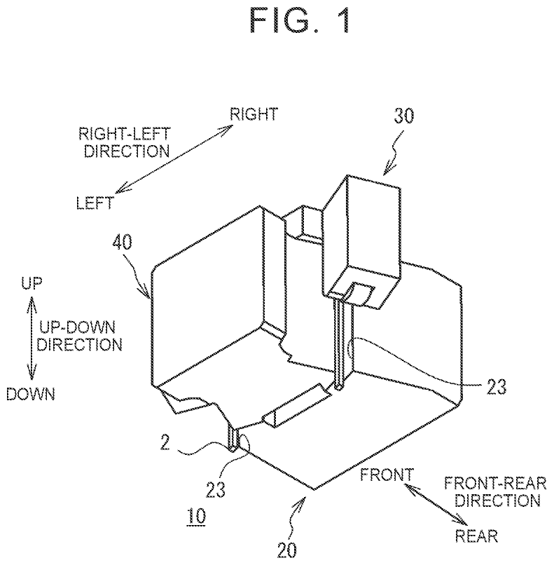

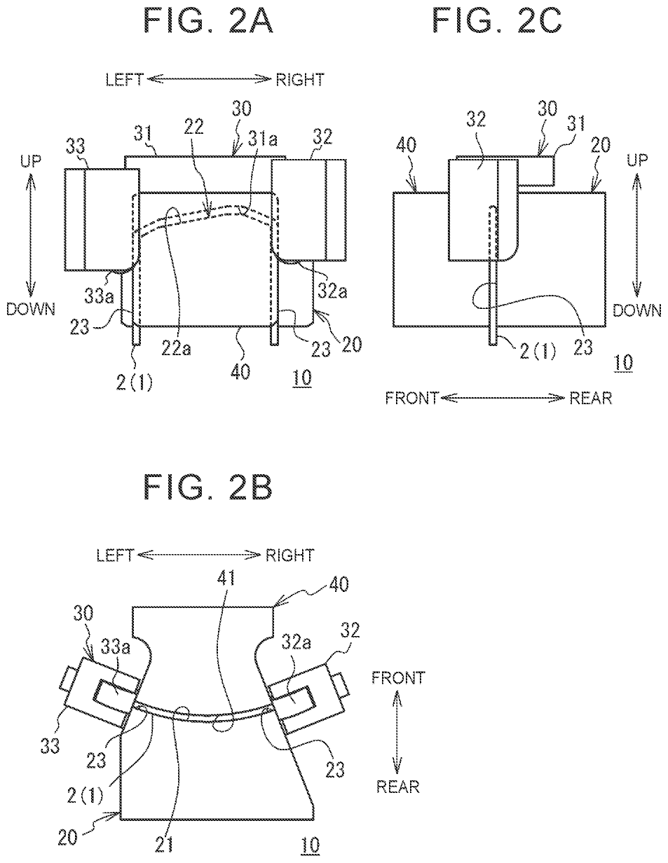

First, with reference to FIGS. 1 and 2A to 2C, a schematic configuration of a segment coil forming apparatus (hereinafter just referred to as “forming apparatus”) 10 of the embodiment will be described. The forming apparatus 10 forms a segment coil 2 that is one of components of a motor that is one example of a rotary electric machine. The segment coil 2 is combined with a stator core having a cylindrical shape to form a stator coil (not illustrated). The stator core includes slots into each of which the segment coil 2 is inserted along the circumferential direction of the stator core. By placing a plurality of segment coils 2 along the circumferential direction of the stator core, the stator coil is formed. Note that, in the following description, the up-down direction, the right-left direction, and the front-rear direction of the forming apparatus 10 are set as illustrated in FIG. 1. The forming apparatus 10 may operate in a posture different from the posture illustrated in FIG. 1. That is, in a case where the up-down direction illustrated in FIG. 1 is set as a first direction, the right-left direction illustrated in FIG. 1 is set as a second direction, and the front-rear direction illustrated in FIG. 1 is set as a third direction, the forming apparatus 10 may operate in a state where an axis extending along the first direction is inclined, for example, while the positional relationship between the three directions are maintained.

The forming apparatus 10 includes a first forming die 20, a second forming die 30, and a third forming die 40. The first forming die 20 and the second forming die 30 are provided movably relative to each other in the up-down direction (the first direction). In the present embodiment, the first forming die 20 is a fixed die corresponding to a die, and the second forming die 30 is a movable die corresponding to a punch. The second forming die 30 is attached to an up-down-direction movable stage (not illustrated). When the up-down-direction movable stage operates, the second forming die 30 can come close to and separate from the first forming die 20.

The first forming die 20 and the third forming die 40 are provided movably relative to each other in the front-rear direction. In the present embodiment, the first forming die 20 is a fixed die, and the third forming die 40 is a movable die. The third forming die 40 is attached to a front-rear-direction movable stage (not illustrated). When the front-rear-direction movable stage operates, the third forming die 40 can come close to and separate from the first forming die 20.

Segment Coil

Here, in order to make it easy to understand the detailed shape and the function of each part of the first forming die 20, the second forming die 30, and the third forming die 40, the segment coil 2 to be formed by the forming apparatus 10 will be described before descriptions about the first forming die 20, the second forming die 30, and the third forming die 40 are made.

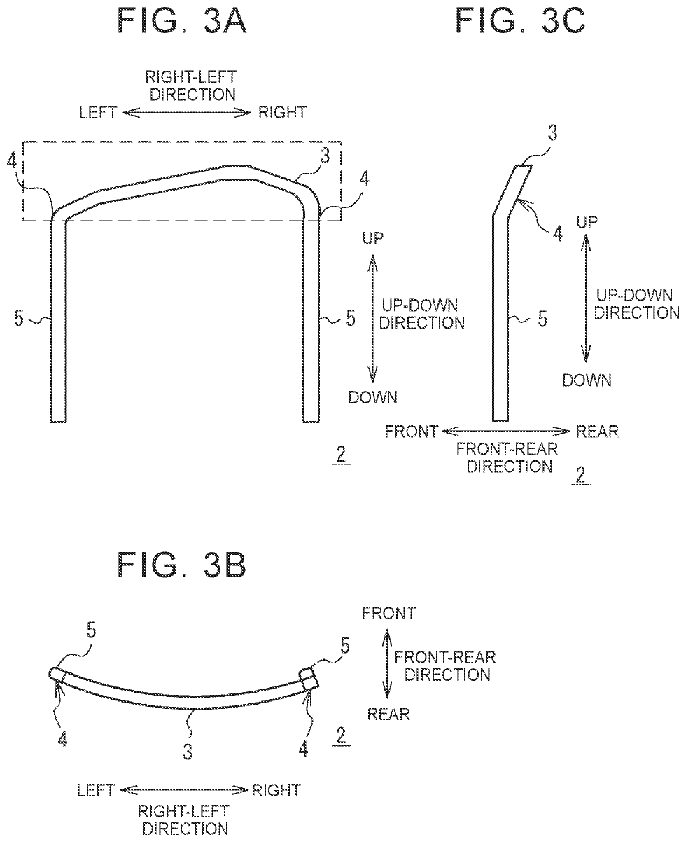

With reference to FIGS. 3A to 3C, the segment coil 2 includes a projection portion 3, and respective shoulder portions 4 provided in right and left side portions of the projection portion 3. The projection portion 3 is a part projecting upward from the shoulder portions 4, that is, a part positioned upward from the positions of the shoulder portions 4. In the present embodiment, a part surrounded by a dotted line in FIG. 3A corresponds to the projection portion 3. The projection portion 3 has a shape that can avoid interference between adjacent segment cores when the segment coil 2 is attached to the stator core.

The segment coil 2 includes end portions 5 extending from respective shoulder portions 4 toward a direction reverse to a direction where the projection portion 3 projects, that is, extending downward from the respective shoulder portions 4. The end portions 5 extend downward from the shoulder portions 4 in a leg shape, and the end portions 5 are inserted into slots (not illustrated) of the stator core. The slots are grooves extending radially in the stator core having a cylindrical shape and are provided over the whole circumference of the stator core. The segment coil 2 is provided over adjacent slots.

As well illustrated in FIG. 3B, the projection portion 3 has a curved shape projecting rearward. The projection portion 3 is formed in a curved shape so that, in a case where the segment coil 2 is provided over adjacent slots provided in the stator core, the projection portion 3 follows the cylindrical shape of the stator core.

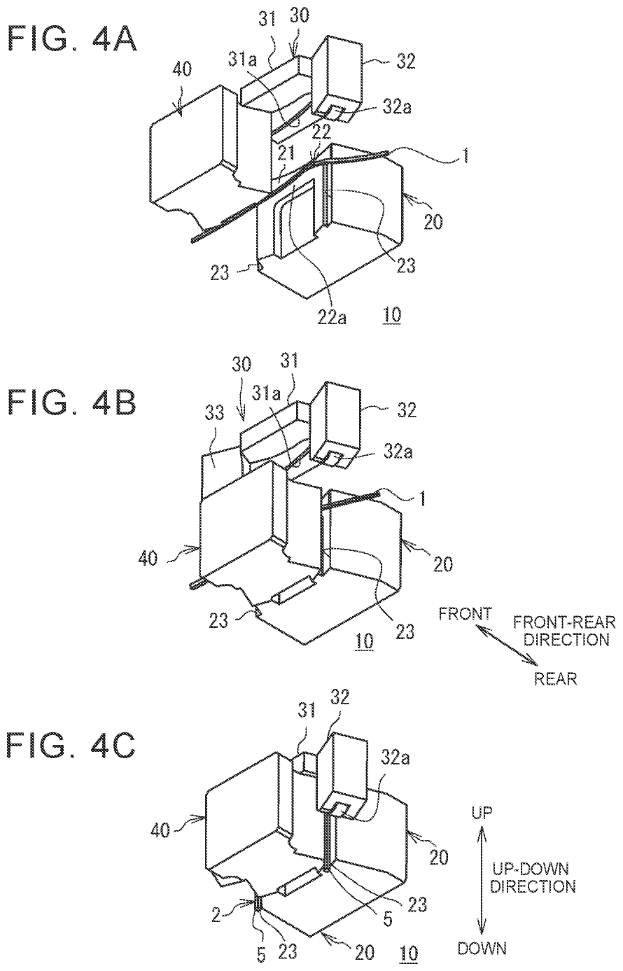

The segment coil 2 is formed such that each part of a wire rod 1 (e.g., see FIG. 4A) as a flat wire made of copper is appropriately bent by the forming apparatus 10. Here, the projection portion 3 and the shoulder portions 4 are both formed by bending the wire rod 1 along the up-down direction. In view of this, the forming apparatus 10 of the present embodiment forms the projection portion 3 and the shoulder portions 4 by relatively moving the forming dies along one axis along the up-down direction. As the wire rod 1, other materials excellent in conductivity may be used.

Note that the shape of the segment coil 2 illustrated in FIGS. 3A to 3C is one example, and the segment coil 2 can have a shape other than the shape illustrated herein. The projection portion 3 may also have other shapes in some cases. However, in a part placed upward from the shoulder portions 4, a part formed by bending in the up-down direction can be formed together with the shoulder portions 4. Further, the curved shape of the projection portion 3 is not essential, and the segment coil 2 can be configured such that the segment coil 2 does not have a curved shape.

Referring back to FIGS. 2A, 2B, the detailed shape and the function of each part of the first forming die 20, the second forming die 30, and the third forming die 40 will be described.

First Forming Die

The first forming die 20 includes a front-rear-direction recessed portion 21 illustrated in FIG. 2B, and a wire-rod holding stepped portion 22 illustrated in FIG. 2A. Further, the first forming die 20 includes guide grooves 23 provided on both sides of the first forming die 20. The front-rear-direction recessed portion 21 is a part configured to form the curved shape of the projection portion 3 illustrated in FIG. 3B and is formed in a recessed shape directed rearward so as to correspond to the curved shape. The wire-rod holding stepped portion 22 is provided such that the front-rear-direction recessed portion 21 is provided upward from a part where the wire-rod holding stepped portion 22 is provided, and the upper side on this part is recessed rearward from the lower side on this part. The depth of the wire-rod holding stepped portion 22, that is, the width of the wire-rod holding stepped portion 22 in the front-rear direction is set to a dimension that allows the wire rod 1 to be put on the wire-rod holding stepped portion 22 at the time of forming the segment coil 2.

As well illustrated in FIG. 2A, the wire-rod holding stepped portion 22 includes an upwardly projecting portion 22a projecting upward. The upwardly projecting portion 22a corresponds to a first projection forming portion. The shape of the upwardly projecting portion 22a corresponds to the shape of the projection portion 3 of the segment coil 2.

The guide grooves 23 continue from the wire-rod holding stepped portion 22 and extend along the up-down direction. When the end portions 5 extending downward from the shoulder portions 4 are formed, the guide grooves 23 serve as guides.

Second Forming Die

The second forming die 30 includes a main body portion 31, a first shoulder-portion forming portion 32, and a second shoulder-portion forming portion 33. The first shoulder-portion forming portion 32 is provided on the right side of the main body portion 31. The second shoulder-portion forming portion 33 is provided on the left side of the main body portion 31. The main body portion 31, the first shoulder-portion forming portion 32, and the second shoulder-portion forming portion 33 are provided integrally and configured to integrally move in the up-down direction. The second forming die 30 is attached to the up-down-direction movable stage (not illustrated) as describe above, and the first shoulder-portion forming portion 32 and the second shoulder-portion forming portion 33 can move in the up-down direction at the same time by operating the up-down-direction movable stage.

The main body portion 31 includes an upwardly recessed portion 31a. The upwardly recessed portion 31a corresponds to a second projection forming portion. The shape of the upwardly recessed portion 31a corresponds to the shape of the projection portion 3 of the segment coil 2. Further, the upwardly recessed portion 31a is placed to face the upwardly projecting portion 22a provided in the first forming die 20. The upwardly recessed portion 31a forms the projection portion 3 of the segment coil 2 in collaboration with the upwardly projecting portion 22a.

The first shoulder-portion forming portion 32 includes a first roller 32a, and the second shoulder-portion forming portion 33 includes a second roller 33a. When the second forming die 30 moves downward to come close to the first forming die 20, the first roller 32a and the second roller 33a make contact with the wire rod 1 and form the shoulder portions 4 on both sides of the projection portion 3 and the end portions 5 extending downward from the shoulder portions 4. Note that the first roller 32a and the second roller 33a may not be provided. However, when the first roller 32a and the second roller 33a are provided, the wire rod 1 can be smoothly formed by bending.

Third Forming Die

The third forming die 40 includes a front-rear-direction projecting portion 41. The front-rear-direction projecting portion 41 is a part configured to form the curved shape of the projection portion 3 illustrated in FIG. 3B and is formed in a projecting shape directed rearward so as to correspond to the curved shape. As well illustrated in FIG. 2B, the front-rear-direction projecting portion 41 is placed to face the front-rear-direction recessed portion 21 and forms the curved shape of the projection portion 3 in collaboration with the front-rear-direction recessed portion 21. The third forming die 40 is a die configured to easily form the projection portion 3. Therefore, in a case where the segment coil 2 is configured such that the projection portion does not have a curved shape, the third forming die 40 may be omitted. Further, even in a case where the projection portion is formed in a curved shape, a guide piece configured to form the wire rod 1 in a curved shape may be provided in the second forming die instead of the third forming die 40, for example.

Segment Molding Method

Next will be described the forming of the segment coil 2 by use of the forming apparatus 10 with reference to FIGS. 4A to 4C.

First, as illustrated in FIG. 4A, the wire rod 1 is put on the wire-rod holding stepped portion 22 of the first forming die 20 in a state where the second forming die 30 is separated from the first forming die 20 and the third forming die 40 is separated from the first forming die 20.

As illustrated in FIG. 4B, the third forming die 40 is moved toward the first forming die 20. Hereby, the wire rod 1 is bent in collaboration between the front-rear-direction projecting portion 41 and the front-rear-direction recessed portion 21 (see FIG. 2B), so that the projection portion 3 is formed in the curved shape illustrated in FIG. 3B.

Subsequently, as illustrated in FIG. 4C, the second forming die 30 is moved (moved downward) toward the first forming die 20. Hereby, the wire rod 1 is bent in collaboration between the upwardly projecting portion 22a and the upwardly recessed portion 31a (see FIG. 2A), so that the projection portion 3, the shoulder portions 4, and the end portions 5 are formed.

Thus, in the forming apparatus 10 in the present embodiment, the projection portion 3, the shoulder portions 4, and the end portions 5 are formed by just moving the second forming die 30 toward the first forming die 20. If the main body portion 31, the first shoulder-portion forming portion 32, and the second shoulder-portion forming portion 33 included in the second forming die 30 are provided separately and operated individually, a cycle time required to form the segment coil 2 increases. In the meantime, by use of the forming apparatus 10 in the present embodiment, it is possible to collectively move forming dies in the same direction (in the up-down direction in the present embodiment), thereby making it possible to shorten the cycle time required to form the segment coil 2. Further, by collectively moving the forming dies in the same direction, it is possible to reduce the number of driving portions, and this is also advantageous in capital investments. In the present embodiment, the movement of the main body portion 31 configured to form the projection portion 3 and the movement of the first shoulder-portion forming portion 32 and the second shoulder-portion forming portion 33 configured to form the shoulder portions 4 can be achieved by the movement of the up-down-direction movable stage, thereby making it possible to restrain capital investments.

In the forming apparatus 10 of the present embodiment, the second forming die 30 includes the first shoulder-portion forming portion 32 and the second shoulder-portion forming portion 33 on both sides of the upwardly recessed portion 31a. Accordingly, by moving the second forming die 30, it is possible to form the projection portion 3 and to form the shoulder portions 4. Hereby, it is possible to shorten the cycle time required to form the segment coil 2.

Further, since the first roller 32a and the second roller 33a are provided, it is possible to smoothly form the wire rod 1 by bending and to form the shoulder portions 4 and the end portions 5.

The above embodiment is just an example to carry out the present disclosure. The present disclosure is not limited to the above embodiment. It is obvious from the above description that various modification of the embodiment are included within the scope of the present disclosure, and further, the present disclosure is achievable in various other embodiments within the scope of the present disclosure.

What is claimed is:

1. A segment coil forming apparatus for forming a segment coil from a wire rod, the segment coil including a projection portion, shoulder portions provided in both side portions of the projection portion, and end portions extending from the shoulder portions toward a direction reverse to a direction where the projection portion projects, the segment coil forming apparatus comprising:
a first forming die including a first projection forming portion corresponding to a shape of the projection portion; and
a second forming die including a second projection forming portion corresponding to the shape of the projection portion, the second forming die including shoulder-portion forming portions provided on both sides of the second projection forming portion, the shoulder-portion forming portions being configured to form the shoulder portions, the second forming die being provided such that the second forming die relatively comes close to and separates from the first forming die in a state where the second projection forming portion faces the first projection forming portion.

2. The segment coil forming apparatus according to claim 1, wherein each of the shoulder-portion forming portions includes a roller configured to make contact with the wire rod when the first forming die and the second forming die come close to each other.

3. A segment coil forming method for forming a segment coil from a wire rod, the segment coil including a projection portion, shoulder portions provided in both side portions of the projection portion, and end portions extending from the shoulder portions toward a direction reverse to a direction where the projection portion projects, the segment coil forming method comprising:
forming the projecting portion and forming the shoulder portions by bringing a first forming die and a second forming die close to each other, the first forming die including a first projection forming portion corresponding to a shape of the projection portion, the second forming die including a second projection forming portion corresponding to the shape of the projection portion, the first forming die and the second forming die being brought close to each other in a state where the first projection forming portion and the second projection forming portion face each other.
